(19) United States
(12) Patent Application Publication
(10) Pub. No.: US 2008/0028308 A1
(43) Pub. Date: Jan. 31, 2008

(54) Visual display method for sequential data

(75) Inventors: James Scott Brownlee, Calgary (CA); Craig Johnston Burns, Vancouver (CA); Robert Richard Grant, Vancouver (CA); Kenneth Adam Kwasnicki, Vancouver (CA)

Correspondence Address: Black Fin Software Limited;Atten: James Scott BROWNNLEE, 7th Floor, 2 Airways House, High Street, Silema, SLM 15, omitted

(73) Assignee: BLACK FIN SOFTWARE LIMITED

(21) Appl. No.: 11/878,954

(22) Filed: Jul. 30, 2007

Related U.S. Application Data
(60) Provisional application No. 60/834,159, filed on Jul. 31, 2006.

(51) Int. Cl. G06F 3/14

(52) U.S. Cl. 715/275; 715/273

(57) ABSTRACT

A method of displaying linearly ranked data items that involves fixed patterns and user-responsive visual prominence to improve user consideration of those results. Ranked Data Items can be generated dynamically via a search engine or be a historical record of collected Data Items over time and ranked by the user. The plotting of the Ranked Data Items on the non-linear results space can be shared with other networked users.

### CROSS-REFERENCE TO RELATED APPLICATION

This application claims the benefit of U.S. provisional patent application 60/834,159, filed Jul. 31, 2006. That application is incorporated by reference along with all other references cited in this application.

### FIELD OF THE INVENTION

The present invention relates generally to the display of information on a computer system display.

### BACKGROUND OF INVENTION

Search engine results from Google® (registered trademark of Google Inc.) or eBay® (registered trademark of eBay Inc.) on the World Wide Web are conventionally displayed in a linearly ranked list (from the top to the bottom of a Web page as viewed on a typical computer monitor screen). It is recognized that the first, highest ranked item on that list may not be, and often is not, what the user is really looking for, and that what is closer may be further down the list.

One limitation of this linearly ranked display format is the limited number of results that can be displayed in the user viewable area of the screen (herein, “view space” or “display space”), and the consequential exclusion of information that may be important to the user's objectives.

A second limitation, accentuated by the limited view space, is the constraint on a user to make effective comparisons among the search results he is presented.

A third limitation of some conventional methods of displaying search results is the lack of visual information to support accurate and efficient identification of the desired result. For example, each Google® text search result “looks” very much like every other result. If the user isn't certain of the words that describe the result he truly seeks, such that a quick scan of the screen would pick it up, he soon succumbs to reading the header text and body copy associated with each result, slowing down his making of comparisons among the results.

Conventional attempts to address some of these limitations do so by displaying the results in a non-linear format. But these attempts introduced their own limitations. Some attempts have a “degree of relevancy” factor in their placement of results for user viewing, where such factor is out of the control of the user—this leads to results rarely being displayed in the same place twice, thereby forcing the user to “learn” a new placement each time. This leads to confusion of the user as he not only has to compare information among the plurality of results, but he also must interpret the placement of results in the non-linear format. These limitations result in less accurate and more time consuming searches than desirable.

### SUMMARY OF THE INVENTION

There is provided a method for displaying within a predetermined user view space, a plurality of data items that are linearly ranked in sequence from highest to lowest, comprising the step of: displaying in a predetermined and stable, non-linear way, said plurality of ranked items.

There is also provided a system for displaying within a predetermined user view space, a plurality of data items that are linearly ranked in sequence from highest to lowest, comprising a Data Retrieval API Engine and a Visual Prominence Engine for the display of said plurality in a predetermined and stable, non-linear way.

In addition, the display of said plurality is on a single, networked workspace that allows for the simultaneous display of many Ranked Items from many users, and allows for those users to share their collections of Ranked Items through known coordinates of the workspace, known as the Non-linear Results Space.

### BRIEF DESCRIPTION OF THE DRAWINGS

A better understanding of the present invention can be obtained when the following detailed description of the preferred embodiment is considered in conjunction with the following drawings, in which:

FIG. 1 shows an example of invention implemented as a method of displaying search results.

FIG. 2 shows an example of the invention with Ranked Data Items viewed in a Non-Linear Results Space.

FIG. 3 shows a conventional display of Ranked Data Items (prior art).

FIG. 4 shows the invention's processes that form the Rich Display Paradigm (RDP).

FIG. 5 shows an example of a Display Data Item.

FIG. 6 shows a spiral algorithm.

FIG. 7 shows a concentric circle algorithm.

FIG. 8 shows an advertising algorithm.

FIG. 9 shows a fan algorithm.

FIG. 10 shows a quarter concentric circle algorithm.

FIG. 11 shows an example of a culturally responsive algorithm

FIG. 12 shows a user-defined algorithm.

FIG. 13 shows a clock algorithm.

FIG. 14 shows an example of the Non-Linear Results Space with user defined plotting of Display Data Items.

FIG. 15 shows a drawing of the relationship between the XYZ Lens and the Non-Linear Results Space.

FIG. 16 shows an example of the conventional use of EBay® (prior art).

FIG. 17 shows an example of the use of the invention in the EBay® environment.

FIG. 18 shows an example of the use of the invention displaying result items from EBay®.

### DETAILED DESCRIPTION OF THE PREFERRED EMBODIMENT

NOTICE REGARDING COPYRIGHTED MATERIAL. A portion of the disclosure of this patent document contains material which is subject to copyright protection. The copyright owner has no objection to the facsimile reproduction by anyone of the patent document or the patent disclosure as it appears in the Patent Office file or records, but otherwise reserves all copyright rights whatsoever.

This invention shows a method for displaying within a predetermined visual “real estate” of the computer monitor for a user, a plurality of Ranked Data Items (as that term is explained herein) that are linearly ranked from highest in descending order, comprising the step of displaying in a predetermined and stable, non-linear way that also facilitates the user making improved comparisons of information among a plurality of the Ranked Data Items. Thus this invention creates a Non-Linear Results Space from the Ranked Data Items with fixed, repeatable positions for each rank of a ranked plurality of Data Items. Furthermore, with said fixed, repeatable positions, the user is easily trainable on the interface paradigm as taught by this invention.

In doing so, the invention, in the step of creating a Non-Linear Results Space, includes giving visual prominence (for the user's viewing of the display space) to said plurality of Ranked Data Items as a function of their respective proximity to the highest Ranked Data Item (whereby each Ranked Data Item has proximity to the highest Ranked Data Item, defined by a single integer, or potentially multiple integers). For example, the fifth Ranked Data Item could be considered to be “four” nominal units away from the first, highest Ranked Data Item, and the third Ranked Data Item could be considered to be “two” nominal units away. As will be explained below, visual prominence can take many forms (including color, granularity, location).

This invention proposes new types of displays that lose less information than the conventional linear display by providing a visual representation of data items in a non-linear display (i.e. compared to a line, a picture is worth a thousand words). The resultant non-linear display thus provides the user a more effective experience in analyzing his results from the search engine and associated database. The invention is more effective because it takes a predetermined, limited display space and provides more information within that space, facilitates improved comparisons among said information, and presents it in a repeatable, and therefore trainable, format.

The invention recognizes that “relevancy is in the eye of the beholder” and should not be under the grip of a “degree of relevancy” formula of the search engine that may be totally outside the knowledge, not to mention control, of the user; and that, instead of trying to predetermine what is most relevant to that user, it is better to manage the display space in a way to provide the user with additional information not currently made available, and therefore to help him compare a plurality of information in a more efficient manner. At the same time, this invention does not presuppose what is “relevant” to the user, but instead concentrates on improving the use of the display space by providing more individual and comparative information (visual, textual).

For example, consider a typical Google ® search result of nine Ranked Data Items that are conventionally displayed from top to bottom. It is more effective for the user if all nine Ranked Data Items were organized in a non-linear order, wherein the first Ranked Data Item (according to the search engine ranking) was at the center of his display space and the next eight Ranked Data Items were displayed in their ranked order but encircling the center Ranked Data Item (like a bulls eye). This way, seven of those eight remaining Ranked Data Items are displayed more proximate to the center, first Ranked Data Item than in the conventional top-bottom display, thereby allowing a user to make a more efficient comparison among all nine Ranked Data Items. Furthermore, if the Ranked Data Items are of a nature that a representative image is appropriate, images (created or retrieved) of the nine Data Items provide additional visual cues for the user to gain additional information about the Ranked Data Item and compare it to other Ranked Data item because their corresponding Display Data Item is visually enriched. This enables the user to make a personal judgment to the “relevancy” of each Ranked Data Item that resulted from his original search query. Because of the visual information that the invention provides of the Display Data Item, it can be likened to the experience of looking at products on a grocery store shelf, whereby a quick scan with the eye helps the user focus in on an item of interest.

Because the Display Data Items are plotted on the Non-Linear Results Space based on a display formula, the only information required to decide placement of these Display Data Items is a simple ranking produced by conventional search engines such as Google® or eBay®. No additional information (such as degree of relevancy or proximity, or clustering algorithm) is necessary to plot Display Data Items. Accordingly, the invention lends itself to familiarity over multiple search queries by the user over a period of time. Due to the nature of the rigidity of the Display Formula, the first Display Data Item will always appear in a predetermined location on the Non-Linear Results Space, and, for example, the eleventh Display Data Item will always also appear in its predetermined space. This predetermined and stable characteristic of the display formulae creates a trainable environment for the user and thereby enhances the effectiveness of the user interface.

Additionally, by utilizing the display space in a non-linear manner, other attributes of the Ranked Data Items which are or may be lost in a conventional linear display, can be conveyed through the interface with the user with this invention. For example, spatial attributes such as magnification and zooming, can improve the volume of information transferred to the user in the predetermined display space.

Using Display Data Items advantageously retains, transfers and can also provide additional information to the user in a spatially constrained view space when compared to the more limited information transfer capabilities of simple text.

The present invention involves displaying Ranked Data Items from a retrieval system (web based search engine, SQL search queries on private databases, and so forth) on a Non-Linear Results Space and plotting the corresponding Display Data Items using an algorithm (such as a spiral, fan, or concentric circles, as explained below) of dimension N, where N is greater than 1, rather than the conventional linear order, where N equals 1 (a simple linear list).

Although the conventional search engine, operating on its proprietary database, typically produces multi-dimensional information, they display the results in the most trivial way, a linear display. The compression of multi-dimensional information to a linear dimension for display purposes loses information useful for the user in his search quest. This invention loses less information than the linear display by using visual prominence techniques, and in some instances, can actually display more information than is currently possible with a conventional linear display.

An example of linear display is the conventional ranking, top to bottom, without any visual differentiation between Data Items other than order. The only information (n=1) is sequential. The display provides no other information.

$$\begin{matrix}1 \\ 2 \\ 3\end{matrix}$$

An example of a non-linear display of the same Data Items used in the linear display, yet applying non-linear display principles provides the following.

$$\begin{matrix}1 & 4 & 7 \\ 2 & 5 & 8 \\ 3 & 6 & 9\end{matrix}$$

The above display is able to insert nine Ranked Data Items in a predetermined display space simply by utilizing the space to the right of what in a conventional linear display space would be occupied by only three Ranked Data Items. What is important to recognize is that there is no requirement for a predetermined degree of relevancy among Ranked Data Items in plotting Display Data Items on the Non-Linear Results Space. In fact, in the extreme case, the Ranked Data Items can be unrelated to each other and the invention would still operate usefully as described. Unrelated Data Items will not render the invention inoperable, and instead, the corresponding Display Data Items could still be meaningfully considered by the user.

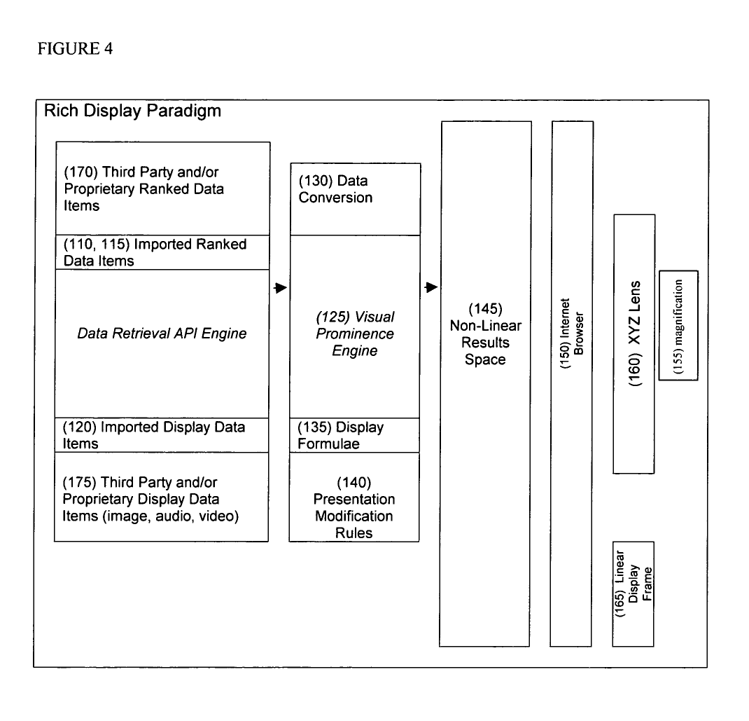

The invention, termed herein the Rich Display Paradigm (FIG. 4), is the outcome of the entirety of the following four steps/elements.

The Data Retrieval API Engine is the first step in the Rich Display Paradigm. It begins by receiving Ranked Data Items.

Ranked Data Items is a list of data items returned from a query on a data retrieval system or systems (web based search engine like Google ® or eBay®, SQL query on a private database, or a user-based ranked data items). The data items are presented in a ranked format, indicating a primary or highest ranked data item and sequentially ranked data items as related to the highest ranked data item. The data items can be itemized across one dimension, a line, one following the other. Data items are constructs of metadata such as descriptive text, URLs, keywords, date, and time stamps.

Secondly, once Ranked Data Items are retrieved, the Data Retrieval API Engine sources or generates Display Data Items.

A Display Data Item is an affiliate or representative image, audio, or video item used to represent (or augment the visual prominence on a Data Item. Examples of Display Data Items include a thumbnail image of a Data Item's webpage or an audio clip of a larger musical work.

Thirdly, the Ranked Data Items, and their corresponding, subsequently related Display Data Items, are assembled by the Data Retrieval API Engine, whereby they are forwarded onto the Visual Prominence Engine.

Fourthly, the Visual Prominence Engine completes three major tasks: The conversion of the data for display; the application of a Display Formula; and the application of Presentation Modification Rules.

Display Formula is/are the mathematical equation(s) which establish the relative positions of each Display Data Item within the Non-Linear Results Space.

Presentation Modification Rules define specific visual characteristics of the Non-Linear Results Space. Examples include colour gradients, granularity/resolution, spacing between Display Data Items, shading “active” and “inactive” Display Data Items, interactive tools and their dimensions and availability to the user.

The final result of the above is a Non-linear Results Space (of N-Dimensions) which is, herein, the non-linear results space containing Data Items and Display Data Items resulting from the combination of the above-described four steps/elements, where N is greater than 1. The resulting Non-linear Results Space may or may not be a static construct. For example, applying a Display Formula with decay on time or value may dynamically modify the location of an individual Ranked Data Item and corresponding Display Data Item within the Non-linear Results Space.

The user may or may not be able to view the entire Non-linear Results Space at one time but every part of it can be viewed through a XYZ Lens. The non-linear results space is a single, multi user space, where the RDP plots the Display Data Items in an area selected by the RDP. Simultaneously, the RDP can be plotting other Display Data Items that are the result of other search queries by other users. This all takes place on the same non-linear results space. Users may also save Display Data Items on the non-linear results space for later retrieval and also place Display Data Items on their personally defined ranking model. Users may also record for later retrieval coordinates on the non-linear display space to share with other users or make available publicly.

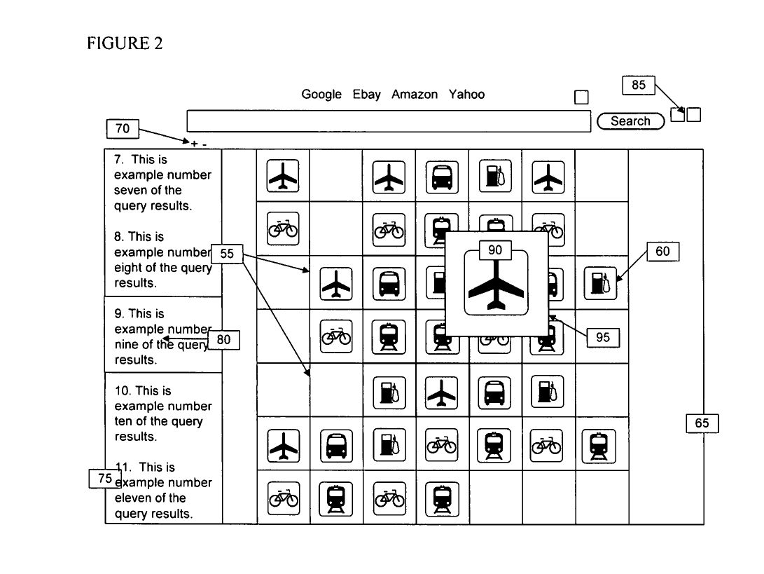

The portion of the Non-linear Results Space (populated by Display Data Items) that can be viewed, in whole or in part by the user on his display, is viewed by user manipulation of the XYZ Lens. The flexible and scalable XYZ Lens provides granularity and navigation in viewing the Non-Linear Results Space. The XYZ Lens allows the user to view results both as text and display data items simultaneously. The XYZ Lens may also provide the user with a simultaneous N=1 representation and N>1 representation of the Non-linear Results Space (see FIG. 2 and associated explanation). Multiple XYZ Lens may be employed to view the Non-linear Results Space, either independently or simultaneously. A XYZ Lens can be caused to change its properties for example, its granularity level or its border dimensions in the display space) by actions taken by the user or automatically by another feature of the RDP.

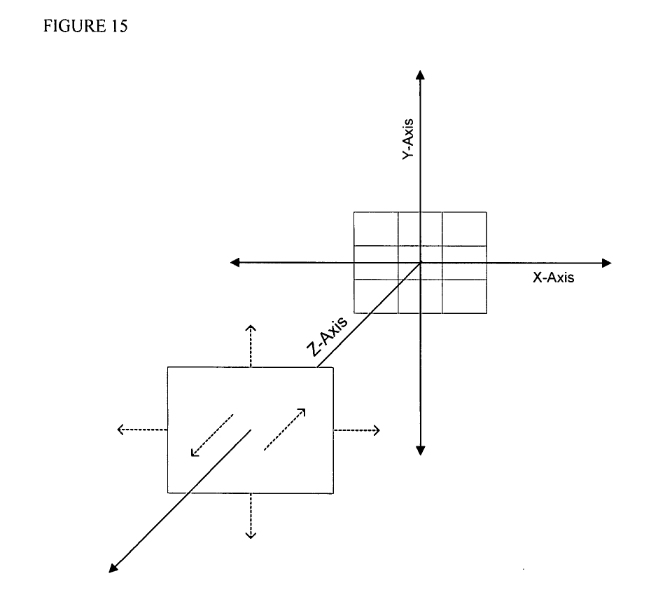

The user may interact with the Non-linear Results Space by moving their cursor within the XYZ Lens (FIG. 15). Cursor movement within the XYZ Lens can simultaneously trigger additional display actions, both within the visible space of the XYZ Lens and/or with the RDP directly. Examples of this are a magnification effect of the Display Data Item when it is located directly under the user's pointer or mouse cursor.

The invention also provides for the presentation of Ranked Data Items in a conventional linearly ranked format (see FIG. 2). This is accomplished through the Linear Display Frame that displays Ranked Data Items in their ranked, linear format. Visual Prominence techniques are also used in the Linear Display Frame to improve the user's understanding thereof. Examples are a Linear Display Frame Highlighter that uses a different colour gradient than that of the Display Data Item over which the user currently has his cursor hovering. The cursor position within the XYZ Lens can also simultaneously change the positioning of the colour gradient on the Linear Display Frame contents.

The Rich Display Paradigm is the entirety of the Ranked Data Items assembled with the Display Data Items by the Data Retrieval API Engine, the output which is then processed by the Presentation Modification Rules and Display Formula of the Visual Prominence Engine, resulting in a Non-linear Results Space which can be viewed by the user, in whole or in part, through a XYZ Lens (and optionally, with a Linear display frame).

Examples will be given below for a Non-Linear Results Space for the purpose of a public search service and for a public online auction service on the WWW, but this invention is not limited thereto. Thus the invention is equally applicable to, for example, a Non-Linear Results Space for ranked data items from a private database (whether of books of the user's private library, his computer “desktop” (of icons, documents, shortcuts), his favorite WWW URLs). Especially in the case of a private database but also relevant for the public database, the ranking to produce Ranked Data Items may be performed by a software program that is controlled by the user so he can introduce his preferences of ranking; or the ranking to produce Ranked Data Items may be performed by the user directly (e.g. he ranks his favorite URLs, books, documents, etc.).

The invention additionally enhances the user's experience using the non-linear display by applying techniques and variables which bring additional visual prominence. An individual Display Data Item may be enhanced with a text pop-out containing additional information, through magnification of individual or groups of Display Data Items, an electronic path may be provided with each Data Item for accessing the source of the Data Item, and, colour gradients, shading, and spacing may facilitate comparisons between data items, and enable the user to improve in their determination of relevancy. The plurality of all ranked data items may be presented in various related pixel sizes (scale), adjustments of ratios between text and visuals, and additional micro search features and reapplication of specific elements to modify the display and/or the Non-linear Results Space. The Non-linear Results Space may also be viewed and interacted with simultaneously or independently in a linear results space as, well as a Non-Linear Results Space.

The Invention retrieves Data Items (the result of a query on one or multiple public or private databases) with as much metadata and ranking information as possible. In a simple embodiment, the invention simply plots the ranked data items on a Cartesian XY plane, known here as the Non-Linear Results Space. However, in a richer embodiment of the invention, visual prominence techniques are applied to the Non-Linear Results Space, and the Non-Linear Results Space itself can be dynamic in its construct (i.e. not a statistic rendering).

Visual prominence techniques would see the application of one or more visual techniques to the Non-Linear Results Space either independently, simultaneously, or sequentially. Examples range from simple image renderings to represent a Ranked Data Item, to various gradients of colour representing positioning of data items, to the more complex application of mathematical Display Formula to optimally plot data items within the Non-Linear Results Space to facilitate user comparisons.

Display Data Items are retrieved images, video, and audio data that can be, but are not limited to, a static image from a stored electronic address or generated dynamically either/or/in combination at a local (client) or remote (server) location. The typical Display Data Item may be a thumbnail image of a result from a search engine or a small digital image of a product from a commerce or auction website. Retrieved thumbnail images are processed by the Rich Display Paradigm to be inserted into the Non-linear Results Space as part of the Display Data Item.

The Visual Prominence Engine provides the user an ability to define unique presentation characteristics and how the user can interact with the Rich Display Paradigm, and ultimately the construction characteristics of the Non-Linear Results Space. The Presentation Modification Rules may also direct visual and layout characteristics such as scale of visual presentation of data items, number of data items, rules governing the XYZ Lens, linear display frame, magnification, zoom, and positioning and formatting of ranked data items and display data items facilitating comparisons among information (including but not exclusive to Search Results).

Display Formulas in this invention is the application of various mathematical algorithms, independently and in combination, to plot Ranked Data Items in the Non-linear Results Space as Display Data Items.

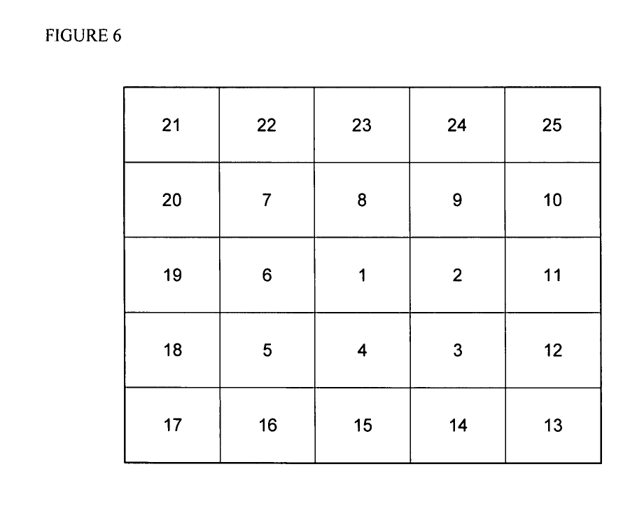

Below is an example of one display formula for the creation of Non-Linear Results Space, referred to as “spiral” (FIG. 6). This formula can have Presentation Modification Rules applied to its calculations when assembling the Non-linear Results Space.

Example of the Spiral Formula:

The display algorithm takes ranked data items and plots the locations in the Non-Linear Results Space as follows:
Let (x,y)=(0,0) be the coordinates for the initial result cell.
Let (dX, dY) be the directional vector for each subsequent cell in the spiral.
Where (1,0) is the initial directional vector values representing an initial step one square to the right. Other initial directions such as Left: (−1,0),
Up (0,−1), or Down (0,1) could be user options.
Let D=[1 or −1] be the user selected direction. Clockwise=1, Counter-clockwise=−1.
To generate the spiral display the following algorithm is applied:

Let NRDI be the total number of Ranked Data Items produced by the search engine.

```
Begin loop from i = 1 to NRDI.
    PlaceResult i^{th} result at coordinates (x,y)
    Let R = Round(√i/2) be the radius from the center coordinates (0,0)
    If (|x| + |dX|) > R
    or (|y| + |dY|) > R
    Then
      Let tX = dX be a temporary storage for dX
      If dX = 0 Then dX = −dY * D
        Else dX = 0
      If dY = 0 Then dY = tX * D
        Else dY = 0
    (x,y) = (x+dX, y+dY) ; update the x,y coordinates for the next cell.
End Loop
```

where “Round” represents the Integer round function such that floating point numbers with fractional components <0.5 are rounded down and otherwise are rounded up.

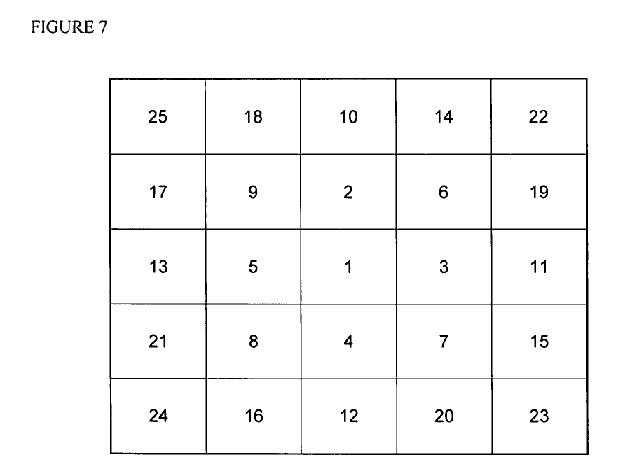

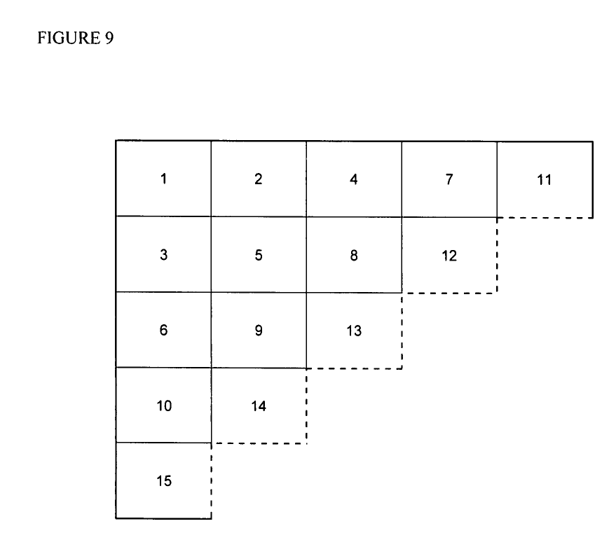

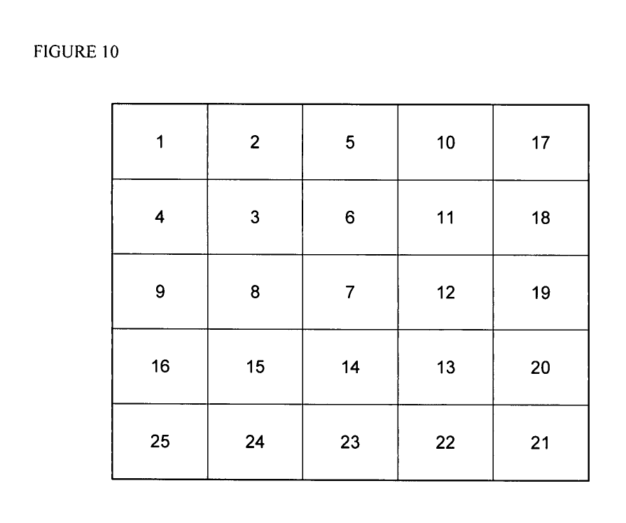

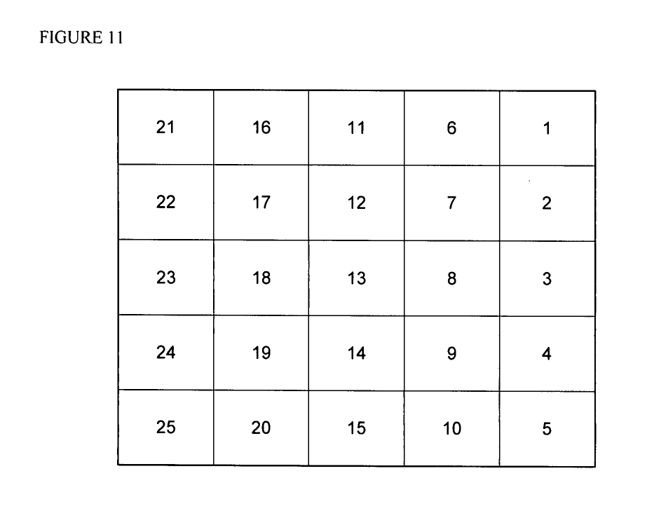

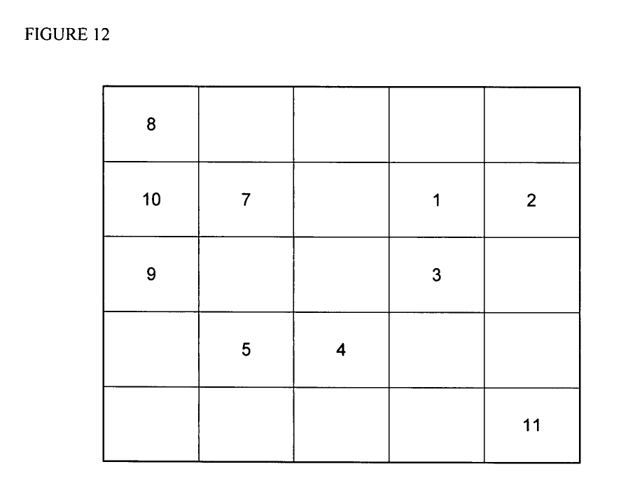

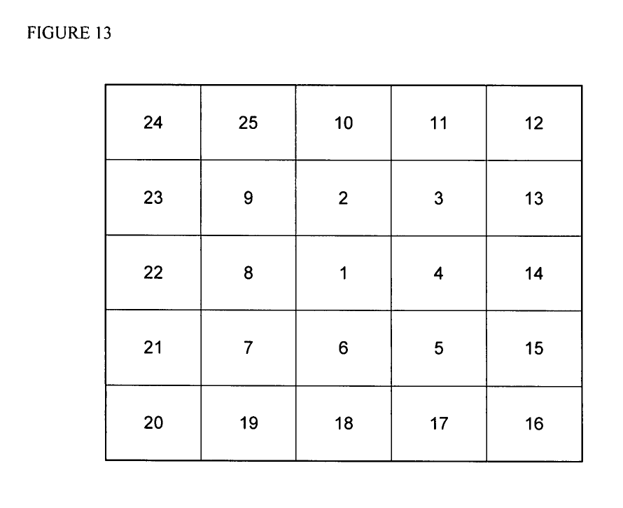

Of course, other non-linear geometric shapes or paths may be advantageous (FIGS. 7 to 15). These shapes or paths are self-explanatory from their drawings by following the ranked sequence (from 1, 2, 3 and so forth). The path of FIG. 11 is worth particular comment. It shows the display in a way that the Japanese user may find more efficient. Japanese text (hiragana, katakana, kanji) is typically presented in a (book or scroll) “sheet” from right to left, top to bottom—the Japanese reader in his system, reads in columns, from top to bottom, from right to left. This may seem strange and inefficient to the English reader who, in his system, is accustomed to reading in rows from top to bottom. Neither system is inherently better than the other. But it is worthwhile to note that to be useful, any system of display must be predetermined and stable over many readings by a user, so that the user can be trained in that system and subsequently read therein efficiently. Upon choosing a particular system of reading (whether Japanese or English, for example), and by analogy to the present invention, upon choosing a particular algorithm for placement of Display Data Items, the user must be presented a predetermined, predictable and stable display for both training and efficient processing of information.

The Non-linear Results Space itself can be a static or dynamic construct, the result of the combination of the above four elements (FIG. 4). In a dynamic embodiment of this invention, Display Data Items may change their visual characteristics and/or positioning while the user is passively viewing the Non-linear Results Space (for example, Ranked Data Items which are time sensitive like auction items, when a Ranked Data Item will disappear because it is no longer available for purchase). In a static embodiment, the Display Data Items do not change positions in the Non-linear Results Space.

A user may also be able to plot individual data items within the Non-Linear Results Space from his computer, and store the plotted coordinates in ranking amongst other individually plotted data items previously placed within the Non-Linear Results Space.

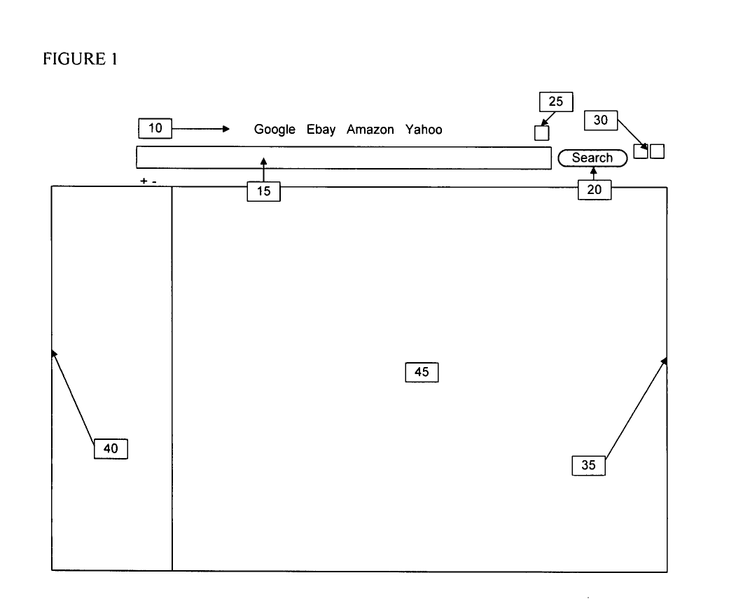

In one embodiment of the invention, the method of access and interaction is through a web browser. The configuration of this web page will have numerous elements to enhance the user experience and improve his ability to make decisions from the information returned in his queries (FIGS. 1 and 2).

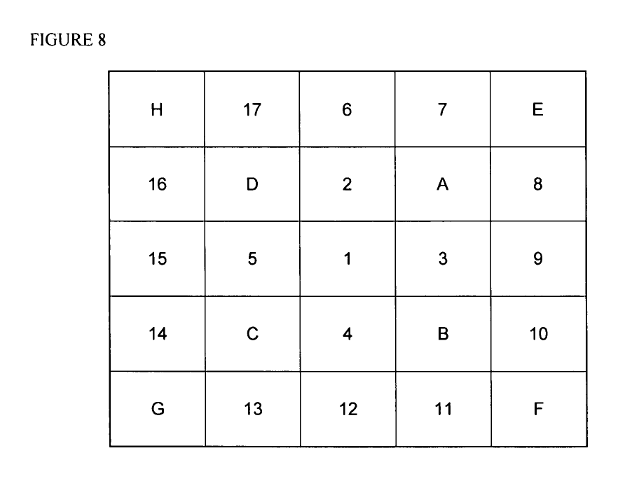

In creating the Non-linear Results Space, the Rich Display Paradigm may also insert Display Data Items and Ranked Data Items related to advertising. Images found in the Non-linear Results Space may have no relevancy connection to the ranked Data Items or may be inserted into the Non-linear Results Space by an Advertising algorithm (FIG. 8). This may include images, video, audio, or text and takes a unique, predefined position within the Non-linear Results Space. These advertising display data items may have an electronic address.

As mentioned above, the Rich Display Paradigm can be re-engaged to reorganize the Data Items in response to a user's evaluation of the first results. If a user reviews the Ranked Data Items displayed in the Rich Display Paradigm, and finds that a Display Data Item that is not the highest ranked Data Item is of more interest to him, the user can initiate a new query based on the metadata information of that more interesting Display Data Item. The user can place the mouse pointer over the particular Display Data Item and select a button (not shown),which then re-engages the Search Engine using the metadata of that particular data item as the basis for its keyword input. This query should (in many cases of search engine algorithms) make that particular Ranked Data Item the primary (ranked 1^{st}) Display Data Item, and the resulting Non-linear Results Space will then be plotted around the Ranked Data Items returned from its metadata.

In the following, the present invention is described in detail with several embodiments and examples. Many of the examples relate to the displaying and presentation of linear search data, creating an improved user interaction through visual prominence techniques in a Non-Linear Results Space.

In one embodiment, the present invention can be written in AJAX, XML, PHP and javascript code, three conventionally languages, ensuring cross-platform operation within various leading web browser applications.

In this example of the implementation of the invention, a user, with access to the World Wide Web, will access the invention through his current web browser using a universal reference locator. FIG. 1 shows an example of what a user would view as his initial start up interface with the invention, using the commonly available and recognized web browser. The user would see various tools and features within the browser display window including a service bar (10), a form text entry field (15), a form submission button (20), visual prominence configuration button (25), relevancy display formulae selection buttons (30), XYZ Lens (35), the linear scrolling highlighter (40), and a portion of a blank Non-Linear Results Space (45).

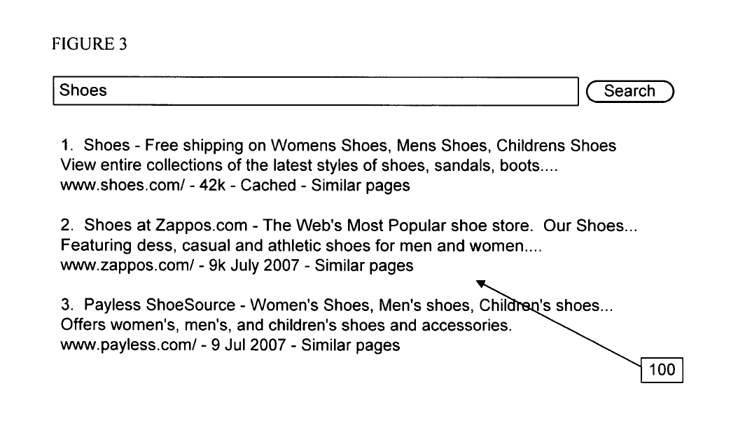

A user selects which service to use to begin a search from the service bar (10). In this example the user has selected the Google® search service. The user then enters his query string in the form entry field (15) and submits it to his preferred service using the submit button (20). At this point, the invention, known as the Rich Display Paradigm (RDP) (FIG. 4) has submitted the query to the preferred service and is awaiting the returned ranked data items (FIG. 3). The ranked data items are then processed by the RDP (FIG. 4) before presentation to the user.

FIG. 2 shows an example of linear results being displayed in a Non-Linear Results Space as seen by the user. The invention returns the Ranked Data Items of the user from the Google® search service and displays the Display Data Items on the Non-Linear Results Space. The invention sets a default visual prominence value for the non-linear display of the Display Data Items. In this example, the colour gradient (55) is highlighting the highest ranked Display Data Item by which all other Display Data Items are referenced, by ranking, and those other Display Data Items are in decreasing gradients of the same colour until reaching the same colour as the background. The scale of the Display Data Items, here represented as thumbnail images (60), is visible to the user through XYZ Lens (65). The user can move the XYZ Lens (65) further away or closer to the Display Data Items on the Non-Linear Results Space either by moving the scroll wheel on his pointing device or using the zoom tools (70). The user can also move the XYZ Lens (65) around the Non-Linear Results Space by clicking and holding the pointing device cursor while located in the XYZ Lens (65).

In this current example of the invention, the Display Data Items are mapped on the Non-Linear Results Space in a spiral algorithm (FIG. 6). The Display Formula (70) defines the placement of Display Data Items on the Non-Linear Results Space. The primary, or first, Display Data Item is located in the centre of the spiral, while subsequent Display Data Items are placed sequentially outward in rings. The linear representation of the Display Data Items using their metadata appears in the linear display frame (75). The linear display frame uses colour shading (80) to highlight the current data item that the mouse cursor is currently hovering over. As the user moves the pointing device cursor over the Non-Linear Results Space, the linear display frame reflects and coincides with the Display Data Item that is directly under the cursor.

When the user places the mouse cursor directly over a Display Data Item, in this example of the invention, it is magnified (90) 50% in size. This helps the user clearly identify his current data item of interest as their focal point. In other embodiments of the invention, magnification can be flexible and increase or decrease to any scale.

The user can change the Display Formula for the Non-Linear Results Space by selecting the Display Formula tool (85). The Display Formula tool can allow the user to re-plot Display Data Items into alternative, fixed positions on the Non-Linear Results Space.

The user can also request a new search based on the metadata of a data item that interests them. In this example, they do this by selecting the “re-search” (95) button on top of the Display Data Item. This submits a new query string to the selected service based on the metadata of that selected Ranked Data Item, in this case, the title text found in the first line of the ranked data item (100). The RDP will receive the new Ranked Data Items and process it for display on the Non-Linear Results Space.

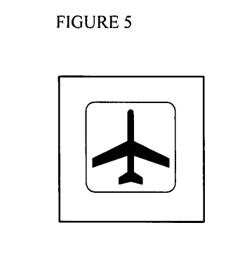

In this example, FIG. 4 represents the various code routines that the RDP undertakes to map a list of Ranked Data Items onto a Non-Linear Results Space. When the resulting Ranked Data Items are received from Google® (170), they are imported through our Data Retrieval API Engine (110). In this example, the data comes from a third party. However, user-defined data items can also be imported into the RDP through the API (115). This allows a user to define what display data items can be included on the Non-Linear Results Space The Data Retrieval API Engine also imports Display Data Items (175). In this example, the Display Data Items (FIG. 5) are thumbnail images from both a third party service and from a local database.

Once the Ranked Data Items have been imported, the RDP begins processing for non-linear visual prominence. This takes place in three distinct software code blocks, occurring concurrently. This is called the Visual Prominence Engine (125).

The Ranked Data Items and Display Data Items are converted to XML for display (130). The Display Formula (135) defines the placement of the Display Data Items on the Non-Linear Results Space. The RDP is not limited to the potential diversity of placements in this Non-Linear Results Space, but in this example, the placement of the Display Data Items is defined by the spiral algorithm (FIG. 6). The Presentation Modification Rules (140) define colour gradients, shading, dimension of various tools (i.e. XYZ Lens), availability of features, Abstract Data resolution, web page layout, font type and size, and spacing between Display Data Items and ranked data items.

The Visual Prominence Engine then produces a Non-linear Results Space (145). The characteristics of this space all having been defined by the previous workings of the entirety of the RDP. The Non-linear Results Space is an environment whereby the Display Data Item is mapped on an XY plane.

In this example, the Non-linear Results Space is viewed and interacted with through XYZ Lens (160), a Linear display frame (165), and a Magnification Tool (155), all implemented in a web page through a client side web browser (150). The operation of these three tools having been described above (FIG. 2).

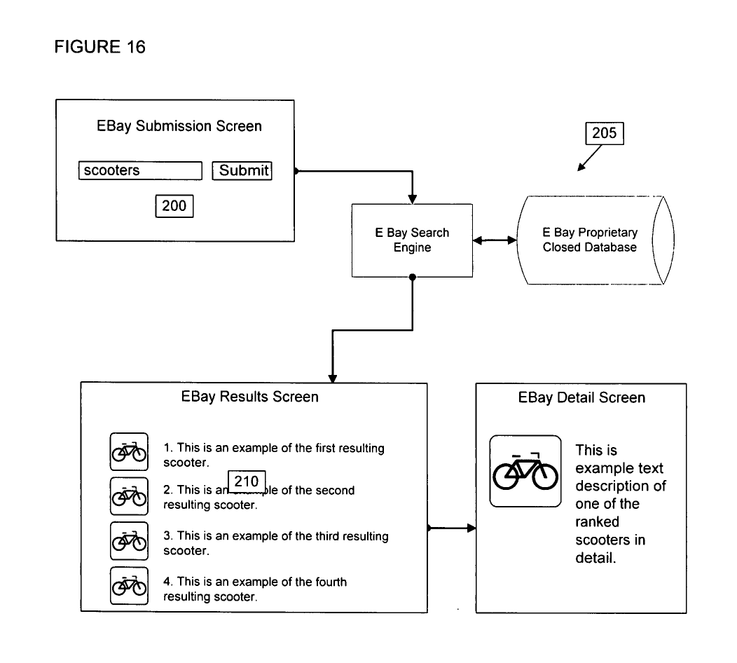

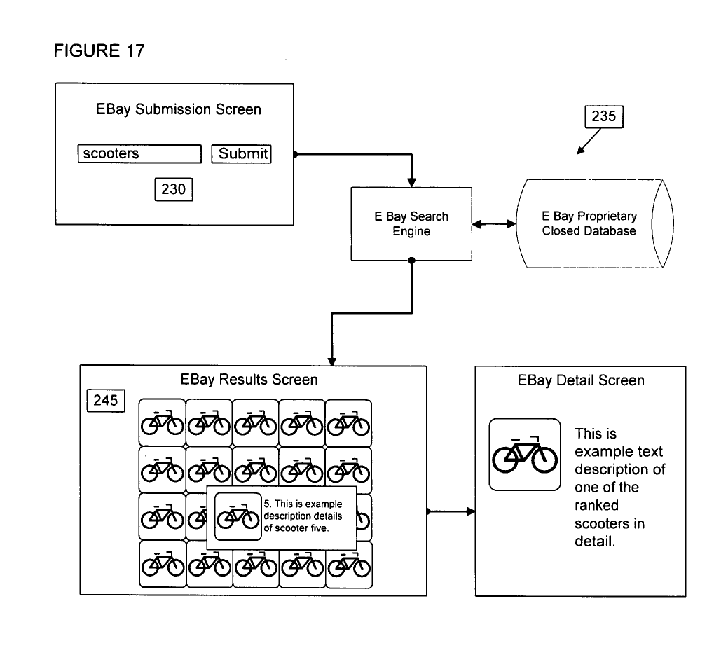

In further describing this invention, we employ the Rich Display Paradigm to an on-line auction website (EBay®) where the ranked data items are normally displayed in a linear display (FIG. 16). We produce through our Rich Display Paradigm, a Non-Linear Results Space of the same Ranked Data Items (FIG. 17).

By plotting in a Non-Linear Results Space the ranked data items generated by the on-line auction search engine, the Rich Display Paradigm facilitates better comparisons and therefore decisions regarding products. Due to the fixed and repeatable placement of Data Items it makes it easier for the user to make decisions on search results because visual information on search criteria they may not have supplied but are just as important to his decision making process are now more obvious. An example would be a search for “scooters”, where the only text reference submitted is “scooters”, but the user may also have criteria such as a desired colour, specific style, specific make/model, specific geographic reference, or specific time left in the auction to make a decision on which item to select, all query text that the user may not have input into the text search field. Our invention may provide this information visually to the user through placement of the display data items (in this example, scooters) in the Non-linear Results Space.

In eBay's® current version, a user goes to the eBay® search page and enters in the name or characteristics of his desired item (e.g. Scooter, Red) in the text entry field (200). The eBay® search engine then searches its proprietary database (205). A linearly ordered results list of ranked data items is returned to the user on his computer display (210).

Several shortcomings are evident (210). First, only a limited number of items can be viewed by the user at any one time. A user can see on the order of eight items on one screen page due to the display space requirements of text based communication. Second, the image for the item is small and therefore limits the visual clues that help a user decide which search item to pursue further.

The following is a typical user experience when interacting with eBay® using the invention. The user would select the number of records they would like returned and the granularity of the display of those records. The user would then submit his search criteria (230) and then the following would happen:

Initiate the search with eBay's proprietary search engine and receive the search results, including the electronic address of each Data Item Result (235).

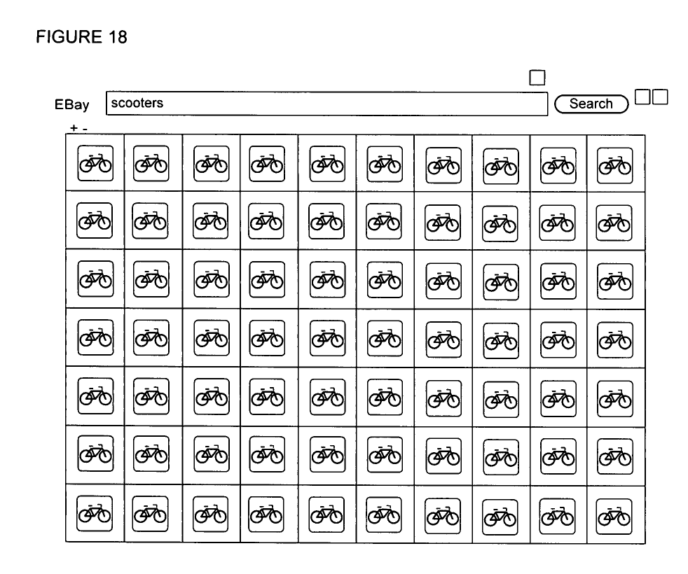

EBay® ranked data items would be processed by the RDP and generate a Non-Linear Results Space (FIG. 18).

The user would view the Non-Linear Results Space through the flexible and scalable XYZ Lens on the webpage in the browser. The user can then navigate around the Non-Linear Results Space through the XYZ Lens. The user can hover the cursor over a specific Display Data Item, get a pop-out box with more detailed information (245), and select that Display Data Item to go to its specific electronic address.

The size and number of items requested will define how many items are visible at one time through the XYZ Lens, and not affect the defined Non-linear Results Space. If all items aren't visible at one time through the XYZ Lens, the user can move the XYZ Lens over the Non-Linear Results Space to see additional items. Variations include: larger scale of images for items closer to the center of the spiral, than those farther away. The user can select a specific item, get a pop-out box with more detailed information, and select that item to go to its electronic address. The user can also hover over a Display Data Item Result to get more detailed information. The user can also initiate a new search using the search query field or selecting a Display Data Item Result and using its meta-data to initiate a new query.

Our invention enhances the conventional EBay® results because it provides more relevant visual prominence to the human cognitive process of examining and sorting through desired products. By presenting EBay® products first by their images and in a much greater cluster, the invention emphasizes the visual desirability of these items and creates a more realistic shopping experience, one that is more familiar to real world shopping than conventionally accomplished online.

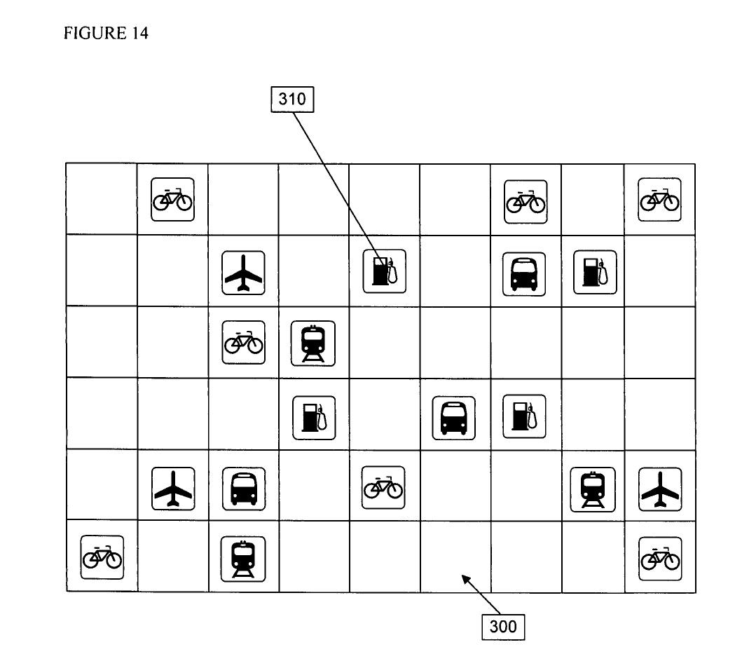

A third example embodiment of the invention is in the plotting of non-ranked data items (or items that are ranked based on a user's personal methodology) on a Non-Linear Results Space (FIG. 14). In this instance a user would select data items (which contain a URL or system locator address) and place them, at his prerogative, at a coordinate of his choosing on the Non-Linear Results Space (XY Cartesian plane) (300). On the Non-Linear Results Space, an abstract data item (310) represents the ranked data item. This abstract data item could be a thumbnail image of the web address, a user defined image, a favicon (“favorites icon”) of that web address, or a system icon for a system locator address.

A key element of this embodiment is the characteristics of the Non-Linear Results Space. The Non-Linear Results Space will expand to accommodate the number of active users multiplied by a pre-defined per-user real estate amount measured in units of URL reference tiles. For instance if the per-user real estate is defined to be 1024 URL tiles, organized in a 32×32 tile square, and there are 100 users of the system, then the size of the Non-Linear Results Space would be at least 102,400 tiles organized in a 320×320 tiles square. The Non-Linear Results Space may be arbitrarily bigger but the above criteria define the minimum available space based on the number of populated users. Therefore, the Non-Linear Results Space is dynamic, and able to expand to satisfy an unlimited number of Display Data Items.

Similar to a current computer desktop display space and the ability to place icons which represent documents, applications, and URLs, there is a distinction between the desktop display space and the Non-Linear Results Space in this embodiment. Whereby a desktop is finite and limited to the local computer from which it operates, the Non-Linear Results Space is not constrained by that local computer. The Non-Linear Results Space is akin to a network desktop, whereby the user is only accessing one section of it. The user can move around the Non-Linear Results Space and see another user's “desktop”. Whereas in its current form, a user's computer “desktop” is finite and private, the Non-Linear Results Space is expandable and shareable.

Second, the Non-Linear Results Space is self-referential. In other words, any given view of the Non-Linear Results Space can be represented by a URL itself containing parameters which define the current location and granularity level of the Non-Linear Results Space. This self-referential URL can be placed at any location within the Non-Linear Results Space thereby creating a “wormhole” connecting one part of the Non-Linear Results Space to another. Just like any other URL reference in the Non-Linear Results Space a “wormhole” can be represented by an image of the web page it represents (being that location of the Non-Linear Results Space in this case) or any other user-defined image.

In this embodiment, there are a number of ways a user can view and interact with the Non-Linear Results Space. This includes XYZ Lens (FIG. 15) with which the resulting Non-Linear Results Space can be viewed, in whole or in part. The flexible and scalable XYZ Lens provides granularity and navigation in viewing the Non-Linear Results Space. A XYZ Lens can be caused to change its properties by the user, the system itself, or by actions occurring in another feature of the RDP (example being the Linear Scroll Highlighter).

The user may interact with the Non-linear Results Space by moving his cursor within the Lens. Cursor movement within the Lens can simultaneously trigger additional display actions, both within the visible space of the XYZ Lens and/or with the RDP directly. The XYZ Lens can change “altitude” above the Non-Linear Results Space (i.e. the Z axis if the two dimensional display is considered the XY plane), and, at any “altitude”, the XYZ Lens can move along the XY axes in any direction.

An example of this is via a click-and-drag mouse action allowing the user to pan the XYZ Lens in either of the x/y directions and thereby browse the entire space. The Non-Linear Results Space can be zoomed in or out by mouse-clicking on software tools provided for triggering the actions of zoom-in or zoom-out, or by using physical human interface device mechanisms such as the scroll-wheel on a mouse, or the arrow keys (or other keys) on a keyboard.

The zoom feature allows the user to expand the granularity of the Non-Linear Results Space to the extent that a single URL image representation fills the entire browser window, or decrease the granularity to the extent that the entire Non-Linear Results Space, at its current maximum boundary, is visible within the browser window.

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

We claim:

1. A method for displaying within a predetermined user view space, a plurality of data items that are linearly ranked in sequence from highest to lowest, comprising the step of:
displaying in a predetermined and stable, non-linear way, said plurality of ranked items.

2. The method of claim 1 wherein the step of displaying includes giving visual prominence to each of said plurality of data items as a function of their ranking.

3. The method of claim 2, wherein the step of giving visual prominence includes colouring of one said data item as a function of its ranking.

4. The method of claim 3, wherein the display of each said data item is framed in colour and its colour lightens as a function of its ranking.

5. The method of claim 3, wherein the display of each said data item is sized as a function of its ranking.

6. The method of claim 3, wherein the display of each said data item is displayed with a granularity, and its granularity coarsens as a function of its ranking.

7. The method of claim 2, wherein the step of giving visual prominence follows culturally responsive reading formats.

8. The method of claim 2, wherein the step of giving visual prominence includes the placement of the highest ranked data item centrally in the view space.

9. The method of claim 8, wherein the step of displaying includes the placement of said plurality of ranked data items in sequence of ranking, in an approximate spiral originating from said centrally-placed highest ranked data item.

10. The method of claim 2 wherein the step of giving visual prominence includes the placement of the highest ranked data item at the periphery of the view space and the placement of the other items of said plurality in an approximate fan-like arrangement based on said placed highest item.

11. The method of claim 2, wherein each said data item is derived from files of a database, and the ranking is determined according to the relevancy of the contents of the items as determined by one or a combination of the following {third party search engine algorithm, user algorithm implemented by software, user}.

12. The method of claim 1, wherein each data item is derived from the contents of a webpage on the World Wide Web and is represented by its URL.

13. The method of claim 1, wherein each data item is a record of a private or public database and is represented by its metadata.

14. The method of claim 11, wherein the relevancy is parameterized by time-related factors of each said data item including the time of creation thereof, the last viewing time thereof, the number of times viewed thereof.

15. The method of claim 1, wherein each said data item is represented by one of more of a graphic, audio file, video file.

16. The method of claim 2, wherein the step of giving visual prominence for the user's viewing, includes the step of magnifying for user viewing, the displaying of the highest ranked item or the item of interest to the user.

17. The method of claim 16 and the step of magnifying includes one of more of the following activities {activating the display of additional information, changing the colour, opacity, granularity and size of an image, adding a symbol, centering in the display space, adding advertising).

18. The method of claim 2, further comprising means for user guided changing of the portion of the Rich Display Paradigm displayed on the view space.

19. The method of claim 2, wherein the display space (a) linearly displays the Ranked Data Items and (b) displays the Display Data Items of the Rich Display Paradigm, and there is a synchronous connection between said Ranked Data Items of said linear display and the Display Data Items of the Rich Display Paradigm, whereby highlighting a particular Display Data Item on the Rich Display Paradigm display will highlight the corresponding Ranked Data Item on said linear display, and vice versa.

20. A system for displaying within a predetermined user view space, a plurality of data items that are linearly ranked in sequence from highest to lowest, comprising a Data Retrieval API Engine and a Visual Prominence Engine for the display of said plurality in a predetermined and stable, non-linear way.

21. A single, non-linear results space that is shared, publicly or privately, among a plurality of users, where historical and dynamic data items co-exist.
